(19) United States
(12) Patent Application Publication
(10) Pub. No.: US 2022/0277219 A1
(43) Pub. Date: Sep. 1, 2022

(54) SYSTEMS AND METHODS FOR MACHINE LEARNING DATA GENERATION AND VISUALIZATION

(71) Applicant: Saudi Arabian Oil Company, Dhahran (SA)

(72) Inventor: Aminullah Sayed Tora, Dhahran (SA)

(21) Appl. No.: 17/187,469

(22) Filed: Feb. 26, 2021

(51) Int. Cl. G06N 20/00; G06F 16/26

(52) U.S. Cl. CPC G06N 20/00; G06F 16/26

(57) ABSTRACT

A system for machine learning data generation and visualization comprises a processor configured to generate a queue module that receives a data file pertaining to a problem to be addressed using a machine learning model, a feature selector module configured to select features extracted from the data file, a vectorizing module configured to generate vectorized feature data from the features, a feature generation module configured to generate data features with reduced dimensionality from the vectorized data using autoencoding techniques, a model handler module configured to select a machine learning model to analyze the data features with reduced dimensionality, to transmit the model for execution, and to receive the results of the execution, a visualizer module configured to parse a dimensionality of the results and select a visualization approach based on the dimensionality, and an output module configured to provide the results for rendering the visualization approach.

### FIELD OF THE DISCLOSURE

The present invention relates to information technology (IT) security, and, more particularly, relates to a system and method for machine learning data generation and visualization.

### BACKGROUND OF THE DISCLOSURE

Artificial intelligence and machine learning (AI/ML) techniques are currently being employed in numerous applications in a wide range of fields. Recently, AI/ML software platforms have been developed that automate data processing procedures to afford an operator a degree of optionality and control over how machine learning models are trained, and how data is to be analyzed. For example, some platforms provide control over how input data is formatted and provide some choice as to the selection of machine learning algorithms and hyperparameters.

However, the platforms deployed to data suffer from various types of inflexibility in their ability to handle different types of input data, in their ability to generate features from the data, in their ability to apply a range of machine learning techniques and parameters, and in their ability to provide visualizations that enable operators to better analyze the results of AI/ML modelling. Owing to a lack of comprehensive flexibility, determining the optimal features, model, and parameters for a given AI/ML problem can be challenging.

### SUMMARY OF THE DISCLOSURE

The present disclosure describes a non-transitory computer-readable medium comprising instructions which, when executed by a computer system, cause the computer system to carry out a method of machine learning data generation and visualization. The method includes steps of receiving a data file containing data pertinent to a problem to be addressed using a machine learning model, extracting features from the data file, vectorizing the extracted features using a plurality of vectorization techniques into vectorized feature data, generating data features with reduced dimensionality from the vectorized feature data using a plurality of autoencoding techniques, selecting an artificial intelligence/machine learning (AI/ML) model to analyze the data features with reduced dimensionality, receiving results of an execution of the selected AI/ML model, parsing a dimensionality of the received results, selecting a visualization approach for the received results based on the dimensionality and outputting the selected visualization of results of the execution of the selected AI/ML model.

In another aspect, the present disclosure describes a system for machine learning data generation and visualization. The system comprises one or more processors, the processors having access to program instructions that when executed, generate the following modules, a queue module configured to receive a data file pertaining to a problem to be addressed using a machine learning model, a feature selector module configured to select features extracted from the data file, a vectorizing module configured to generate vectorized feature data from the features selected by the feature selector module using a plurality of vectorization techniques, a feature generation module configured to generate data features with reduced dimensionality from the vectorized feature data using a plurality of autoencoding techniques, a model handler module configured to select an artificial intelligence/machine learning (AI/ML) model to analyze the data features with reduced dimensionality, to transmit the model for execution, and to receive the results of the execution of the selected AI/ML model, a visualizer module configured to parse a dimensionality of the results obtained by the model handler module and to select a visualization approach for the obtained results based on the dimensionality, and an output module configured to provide the results to a device for rendering the visualization approach selected by the visualizer module.

### BRIEF DESCRIPTION OF THE DRAWINGS

FIG. 1 is a schematic block diagram of a system for machine learning and data visualization according to an exemplary embodiment of the present invention.

FIG. 2 is a schematic flow diagram of an exemplary embodiment of the flow of functions performed by the cache module according to the present invention.

FIG. 3 is a schematic block diagram of a vectorizer module that vectorizes data using multiple techniques according to an embodiment of the present disclosure.

FIG. 4 is a schematic block diagram of an autoencoder module that generates features using multiple techniques according to an embodiment of the present disclosure.

FIG. 5 is schematic block diagram of an embodiment of the model handler, visualization and output modules according to the present disclosure.

FIG. 6 is a schematic block diagram of another embodiment of a system for machine learning and data visualization according to an exemplary embodiment of the invention.

FIG. 7 is an example user interface for configuring and monitoring the system for data generation and visualization according to the present disclosure.

### DETAILED DESCRIPTION OF CERTAIN EMBODIMENTS OF THE DISCLOSURE

Disclosed herein is a comprehensive artificial intelligence/machine learning (AI/ML platform that provides enhanced visualization features. The platform provides several distinct state machine modules that perform tasks including data collection, transfer, identification, recursive extraction, feature identification & selection, vectorization, and auto-encoding. These steps are preparatory to and are used as inputs to further modules that perform machine learning feature extraction, algorithm selection, model structure and hyperparameter selection, model training and prediction and result visualization. The platform machine learning models are used to train classifiers. For example, in one application, machine learning modules can be trained to classify incoming email or URL data as suspicious versus non-suspicious; in another application, machine learning modules can be trained to identify features in graphical or audio data. All of these steps are performed so as to have operator supervision in the event that fine tuning is desired of various data inputs and parameters used by the modules to optimize prediction accuracy. Importantly, the steps can be varied, repeated and compared to other model executions to help operators better understand and visualize changes in selections that improve results for particular classification problems.

At the outset it is noted that the term “module”, used in the description and accompanying figures, is defined as program code and associated memory resources, that when read and executed by a computer processor, perform certain defined procedures. For example, an “vectorizer module” comprises program code that when executed by a computer processor, performs procedures related to vectorization of data.

Hereinafter the category of techniques encompassed by AI/ML will be referred to collectively for convenience as “machine learning”; it is to be understood that “machine learning” in this context therefore can include artificial intelligence techniques that are normally not classified as machine learning techniques per se.

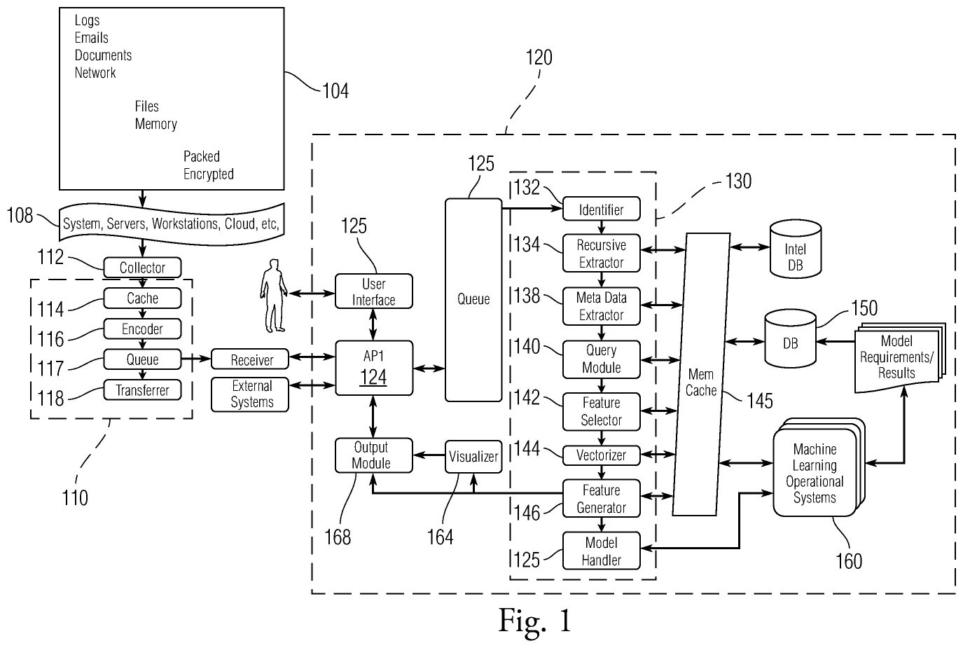

Referring to FIG. 1, a schematic block diagram of an exemplary embodiment of a system for machine learning data generation and visualization according to the present invention is shown. System 100 comprises one or more computing devices having processors configured to execute a group of related program modules. System 100 is conceptually divided into a collector node 110 and a main node 120, which can be embodied (executed) using separate computing devices or processors. Alternatively, the collector node 110 and main node 120 can be executed by a single processor or computing device. The collector node 110 executes a series of modules that collects and processes relevant source data 104 obtained from a plurality of computing resources 108 in which files are stored or linked. The front end 110 includes a collector module 112 that is configured to retrieve data from the computing resources 108, which can include a wide range of computing platforms such as servers, workstations and other computing device located on internal or external networks, such as the “cloud.” In some implementations, the collector module 112 can be configured to retrieve files 104 from a specific source location such as a file share associated with cloud-based services, servers, desktops, mobile systems and devices, databases, and specific applications that store files. The collection module 112 can be configured to collect files of specific types, based on a rule-base configuration that identifies the systems or devices to collect from, the file types, names, and extensions, and related criteria based on file type creation or modification timestamps, permissions, or sizes.

The relevant source data files 104 that can comprise a wide variety of original source types. Example source data 104 files can include one or more of files or byte streams in which relevant data is directly present or embedded as part of some process or function. The relevant data can include textual (alphanumeric), graphic, audio information, and combinations thereof. It is noted that the relevant source data can be presented in an obscured form and can be embedded, encrypted, or otherwise obfuscated. These techniques to obscure or hide data can be taken into account in various machine learning pattern identification algorithms disclosed herein.

Source data obtained from the device sources by the collector module 112 is passed to a cache module 114. The cache module 114 is configured to execute a hash function, such as MD5, SHA1, SHA2, etc., to uniquely identify each file received from the collector module 112. Once a file hash is computed, the cache module 114 performs a lookup of the hash in cache memory to see if the file has been analyzed before. If the hash is found in the lookup procedure, then a response is provided, allowing the cache module to discard the currently reviewed file. Otherwise, the file hash is stored and the file is passed to an encoder module 116 for encoding. The operations of the cache module 114 prevents duplication of effort by avoiding analyzing the same file more than once.

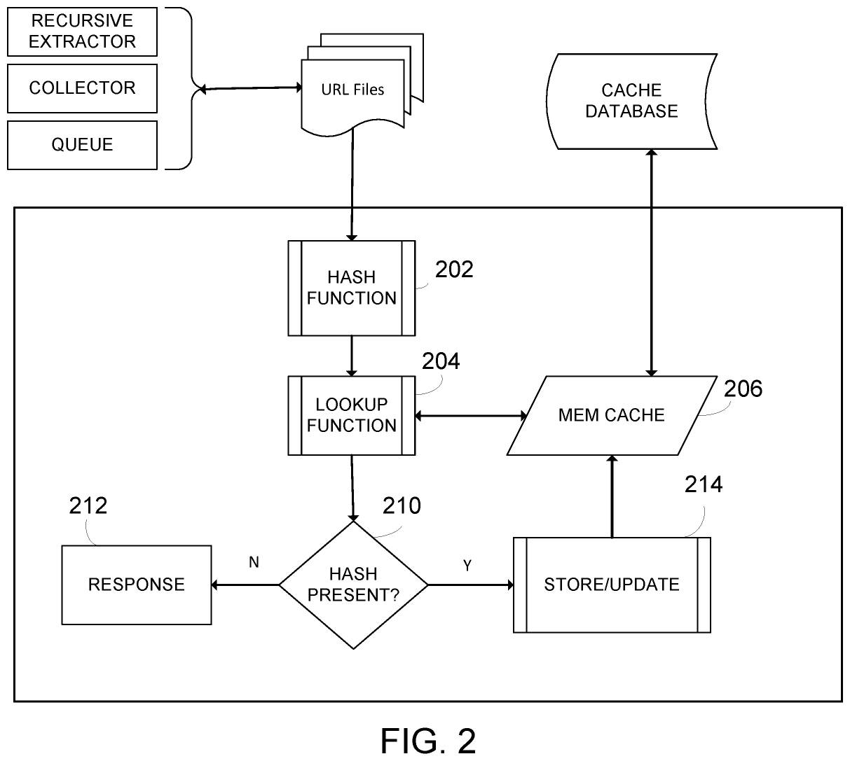

FIG. 2 is a schematic flow diagram of an exemplary embodiment of the flow of functions performed by the cache module 114 according to the present invention that can be used in the forensic analysis systems disclosed herein. As shown, artifacts received are input to a hash function 202, which, as noted, can be a standard hash function well-known in the art such as MD5, SHA1, SHA2. The hash is passed to a lookup function 204 which access memory cache 206 to determine if the hash has been generated previously. In some implementations, the memory cache can periodically load data to a cache database 208, which, in turn, can upload data to a central database. If it is determined (flow element 210), from the results of the lookup function that the hash is already present, e.g., due to a match with data in a memory or database, a response procedure 212 automatically generates a notification which can be passed to system operators. The notification can include text or other codes to inform the operators the ingested artifact has already been analyzed by the system. If it is determined that the hash is new, e.g., due to there not being a match within at least a prescribed tolerance, the hash is stored 214 and the memory cache 206 is updated with an entry of the new hash.

Returning to FIG. 1, if a hash of the file is not found, it is passed to the encoder module 116 to create an identification for the new file. For this purpose, the encoding module 116 is configured to perform an encoding operation, such as simple byte level XOR based encoding with a key, or symmetric encryption algorithm with a key to encode the original file. The encoding allows the file to be transferred and stored without triggering alerts or active responses by system or network-based security apparatus or modules that detect out-of-policy files, malicious files, or patterns. After the encoding procedure, the encoder module 116 passes the encoded file artifact to a queue module 117 that works in tandem with a transfer module 118. The queue module 117 temporarily stores the encoded file in a queue until the transfer module 118 de-queues the file and transfers it to a queue module 122 of the central node 120 via an intermediary receiver and application programming interface (API) 124. The timing of the queuing and de-queuing is determined by the workflow pipeline. For example, when the queue module 122 of the central node 120 signals to the transfer module 118 of the collector node 110 that it is ready to accept a new file for processing, the transfer module 118 is prompted to upload the file to the queue module 122 of the central node.

A user interface 125 also interacts with the API 124 of the central node. The user interface 125 enables operators to submit files and requests directly to the API 124 and enables user control and monitoring of processes of the central node. More generally, the API 124 includes program code that when executed manages traffic between the end users and the rest of the machine learning data generation and visualization system.

The queue module 122 temporarily stores submitted files to maintain an ordered flow of analysis procedures. For instance, if numerous analysis requests are received within a short span of time, the queue module 122 can provide for a first-in first-out (FIFO), last-in first-out (LIFO) or other known method for both ensuring that the system does not get overloaded and that every submission is processed. In addition, another cache queue module de-queues files from the queue and passes the file to a decoder module for decoding (both the cache and decoder modules are not shown for ease of illustration). The decoder module decodes the module using standard byte stream based XOR with a key or symmetric encryption with a key and passes it to back to the cache module. The cache module analyzes the file for duplicate effort as noted above. If the file has not been analyzed, the file artifact is passed back to the queue 122 until the file is de-queued by the analytic module 130.

Submissions are delivered from the queue module 122 in an orderly flow to the analytic module 130 of the system which encompasses a number of sub-modules that perform various pre-processing on the retrieved files to prepare data suitable as input to various machine learning algorithms. The first sub-module of the analysis node is an identifier module 132. The identifier module 132 is configured to analyze file artifacts as a byte stream and to identify the contents of the file as a specific type with a specific format. Additionally, the identifier module 132 is configured to interrogate the file internally utilizing various methods such as byte-stream based “magic header” matching via tables of known file signatures, format indicators, machine and human linguistic syntax analysis to further analyze the file for various characteristics. These techniques are used to further identify embedded files, objects, streams, text data, general executable byte-code patterns, and random or encrypted byte patterns that can be present in the file. Identifications are stored in a central intelligence database 150 via an intermediate memory cache 145.

As the embedded links are identified, the file is passed to a recursive extractor module 134 (“recursive extractor”) that is configured to extract the embedded items from the file recursively. The recursive extractor 134 continues to break down the file into component parts or artifacts until all embedded artifacts have been extracted and no further meaningful data can be obtained from the original file (i.e., the file has been broken down into its minimal constituent elements). One way this can be determined is when an extraction step yields the same artifacts and data as a previous extraction step, indicating that no further artifacts can be yielded from the file. Once each file is reduced down to a non-reducible level, it is passed to a metadata extractor module 136 (“metadata extractor”) that is configured to extract any additional metadata from the file and artifacts such as, but not limited to, links, string patterns, byte-code patterns, magic identifiers, author, creation timestamps, modification timestamps, programming language syntax identification, human language identification, domains, IP addresses, MAC addresses, geo-location identifiers, phone numbers, physical addresses, etc. The extracted metadata is stored in the central database 150. From the metadata extractor 136, the file and artifact data are passed to an additional query sub-module 138. The query module 138 is communicatively coupled to the central database 150 and to other external sources of relevant data. The external sources are collectively represented and referred to as the Intel database 160. The query module 138 collects all results obtain from the queries into a single dataset or multiple datasets for feature selection.

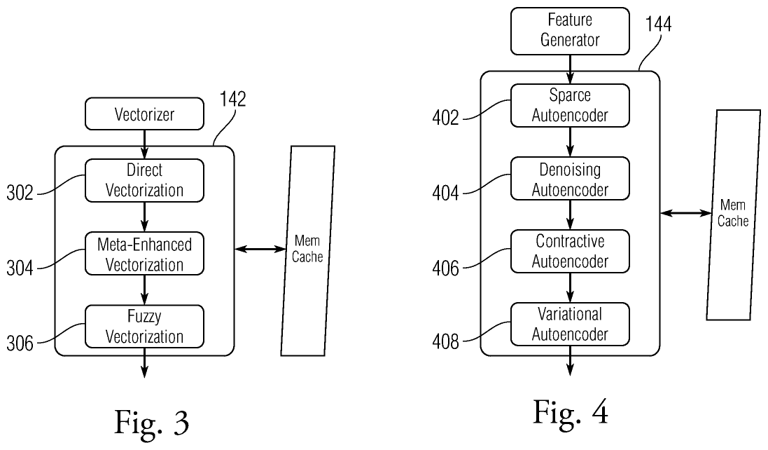

The feature selector module 140 is configured to select data sets or data points from within the newly collected data sets obtained by the query module 138 and to establish a sub-set of data sets or data points for analysis by a vectorizer module 344. FIG. 3 is a schematic diagram of a vectorizer module according to an embodiment of the present disclosure. As depicted, the vectorizer module 142 executes three different vectorization methods (sub-modules) direct vectorization 302, meta-enhanced vectorization 304, and fuzzy vectorization 306 to convert the data sets or data points into vectorized data sets or data points for proper ingestion and computation. Direct vectorization is a direct mapping of the specific byte values of each character of an artifact from a text, UTF-8 or UTF-16 based value into a vector as normally defined in frameworks such as Tensorflow or MXNet. In meta-enhanced vectorization, metadata pertaining to the data of interest can be combined with the actual data as part of the vectorization. Meta-enhanced vectorization can be performed in different modes. For example, in a brute force mode, all permutations of the transformed bytes from the received data artifact and all associated metadata are permuted across to generate all possible vectorizations that are possible. In a set specific mode, a specific set of selected metadata, the byte lengths of the selected metadata, and the mode of the permutation are selected by the operator. Fuzzy vectorization is a derivative of the meta-enhanced vectorization in which additional intelligence data is looked up and related to the relevant data. All associated metadata can be added to the vectorization utilizing the configurations set in the same manner as brute force or set specific as noted above.

The different vectorization methods can be executed simultaneously or in series, and the vectorizer module 142 can be configured to execute all of the method or only a subset of them depending on operator input. All vectorizations are stored in the central database 150 and made available for analysis by following modules, by operators, in some instances, and more generally for future correlations and analyses. The vectorized data sets output by the vectorizer module are provided to the feature generator module 144.

FIG. 4 is a schematic diagram of a feature generator module 144 according to an embodiment of the present disclosure. As depicted, like the vectorizer module 142, the feature generator module 144 executes a plurality of autoencoding algorithms. The autoencoding algorithms generally serve to reduce the dimensionality of the data, effectively compressing the vectorized data, which can contain numerous distinct fields (e.g., hundreds or thousands), into a more information-rich form. In the embodiment shown, the feature generator module 144 includes a sparse autoencoder 402, a denoising autoencoder 404, a contractive autoencoder 406, and a variational autoencoder 408 which employ different compression techniques on the vectorized data sets or data points to generate machine learning ready features. Each of these encoders comprises code that executes in a processor to perform their respective functions. The autoencoders 402-408 techniques can themselves utilize unsupervised machine learning techniques (e.g., neural networks) which enable the feature generator module to learn optimal ways to compress the data. Since all four different techniques are generally executed, simultaneously or in sequence, the different outputs of each technique can be compared, which can reveal important features of the data sets. Importantly, the autoencoding techniques do not require a prejudgment as to which features of the data are most relevant, as the techniques determine this in an autonomic manner.

The purpose of the feature generator module 144 is to convert the input vectorized into the best available features that are most unique, prominent, or of most value in making a decision on the dataset when being trained and predicted on by the model to achieve the model's objective. In this sense, the various autoencoding approaches each have a different transformative effect upon the input vectorized data. The combination of approaches can be used collectively to derive features that can be used in the training and testing process to achieve high value models that are able to achieve their objective with highest degree of confidence.

More specifically, the sparse autoencoder 402 employs a loss function on the input vectorized data that is constructed so that activations are penalized within a layer, which has the effect of favoring fewer layers and reducing the dimensionality of the input data. A sparsity constraint can be imposed with L1 regularization or a KL divergence between expected average neuron activation to an ideal distribution. The denoising autoencoder 404 randomly converts some of the input vectorized data to zero in order to avoid undesired outputs of the identity and null functions. In other words, the denoising autoencoder helps avoid the feature generator arriving at features that are equivalent to the input data and are not helpful in model prediction. The contractive autoencoder 406 is configured by code to avoid overfitting to the vectorized input data by adding a regularizer (penalty) term to whatever cost function is being minimized. Like the sparse autoencoder, the penalty favors the generation of features have fewer parameters than the input data due to the penalties imposed on the weightings of the parameters. The variational autoencoder 408 introduces regularization to avoid overfitting in another way, by encoding input values as distributions rather than as unique values. The variational autoencoder 408 also typically generates compressed data with fewer parameters than the input data due to the manner in which input values are represented. All feature sets generated by autoencoders 402-408 are stored in the central database 150 and made available ingestion by following modules, as well as for current and future operations and analysis by operators.

After features have been generated by the autoencoders 402-408 of the feature generation module 144, the vectorized, compressed data is passed to a model handler module 146. The model handler module 146 generates one or more models based on user-input configuration schema. The models comprise a model structure, hyperparameters, and specific algorithms. The model handler module 146 delivers the set parameters of the selected model(s) to a machine learning operational systems provider 160 (ML implementer) to implement the models for training or prediction. The “models” referred to here are artificial intelligence or machine learning algorithms. Such models can include, but are not limited to, Bayesian, k-Nearest Neighbor (kNN), Support Vector Machines (SVM), and deep learning networks such as convolutional neural networks (CNNs), recurrent neural networks (RNNs), Long Short-Term Memory Networks (LSTMs), Adaboost, Gradient Boosting Machines.

Many of the models are supervised machine learning algorithms (or combinations thereof). Supervised machine learning algorithms employ forward and backward propagation, a loss function and an optimization algorithm such as gradient descent to train a classifier. In each iteration of the optimization algorithm on training data, outputs based on estimated feature weights are propagated forward and the output is compared with data that has been classified (i.e., which has been identified by type). The estimated weights are and then modified during backward propagation based on the difference between the output and the tagged classification as a function of the code used to implement this aspect of the ML algorithm. This occurs continually until the weights are optimized for the training data. Generally, the machine learning algorithm is supervised meaning that it uses human-tagged or classified data as a basis from which to train. However, in a prefatory stage, a non-supervised classification algorithm can be employed for initial classification as well.

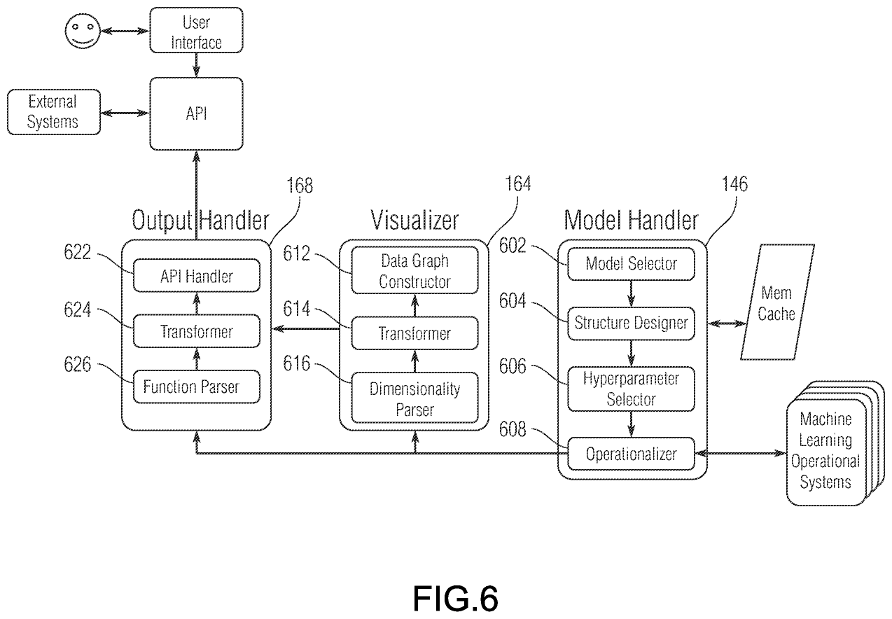

In one exemplary embodiment, shown in FIG. 6, the model handler 146 comprises three submodules: a model type selector 602, a structure design module 604, a hyperparameter selector module 606, and an operation executor 608. The model selector 602 allows the operator to select a general machine learning approach, for example a logistic regression algorithm, a neural network, or a support vector machine, each of which has different structures and parameters. The structure design module 604 allows the operator to establish the structure of whichever model has been selected. For example, neural networks can have many different structures based on the number of layers and inputs. The structure design module 604 is configured to enable the operator to establish the model structure by setting such features, as the inputs, the number of layers, the activation function or the kernel. The hyperparameter module 606 is configured to enable the operator to select the next, finer level of detail that is based on whichever overall approach and structural design has been selected via the model selector 602 and structural design module 604. Hyperparameters include such features as the input data batch size, the learning rate, the number of training epochs to be executed and regularization parameters. All of the these are factors that play a role in the ultimate outcome of the machine learning training and testing process. One all of the model features have been selected, the operational executor 608 arranged for the selected model (or multiple models) to be executed for training or prediction.

These modules 602-608 can present different menus and graphical features through the user interface 125 to aid the user in selecting various features and variables of a machine learning algorithm to test the received data. It should be understood that in alternative embodiments, the functionality of the different modules can be combined in fewer sub-modules or distributed among a larger number of sub-modules. Each module uses the configuration parameters to determine selections for use, including mode, mixture of selections, and variations (i.e., of vectorizing and feature generation techniques, and machine learning model). The configuration parameters also determine when a model passes (successfully meets a threshold) or runs out of time. Configuration parameters are stored as JSON (JavaScript Object Notation) objects for each project or session. In general, the configuration parameters provide guidance and limits as to the approach taken by each module in succession in order to limit the extent of resources being utilized.

The model handler 146 can be configured to select model structures and hyperparameters according to different modes. In a brute force mode, the handler permutes across a set range of all possible values appropriate to each selected model. In a second mode, a range is preselected, and the model handler selects only values from within the set range of values for model hyperparameters, structure, layers, etc. per each machine learning approach and selected models. In addition, a time limit for model evaluation can be set by the operator, which limits the computations of the possible structure and hyperparameter values. The operator can select among the values computed prior to the time limit. The values are dependent on the machine learning approach taken, such as Bayesian, Multi-Variate Bayesian, KNN, SVM, and many others within the Deep Learning approaches.

The operational executor 608 delivers all of the data input regarding the selected model(s) to machine learning operational systems 160 (“ML implementer”), which can be local or cloud-based. Once executed, the ML systems return the results of the training or prediction to the operational executer 608. The operational executor 608 is configured to analyze the outputs of the ML implementer 160. Based on the analysis, the operational executor 608 determines if the training meets threshold criteria configurable by the operator. The threshold criteria typically pertain to the measured accuracy of a model in identifying and classifying the input data. If the training does not meet the set criteria (i.e., is not sufficiently accurate), the operational executor 608 in configured by code to initiate an additional round of feature selection starting at the query module 138. Alternatively, if the threshold criteria are met, the operational executor 608 is configured by code to accept the results and deliver them onward for output and monitoring. Over time, the model handler 146 as a whole can generate numerous different models for the ML implementer 160 to train, and the results of the different models can be analyzed and compared.

The operational executor 608 is configured to evaluate whether the model's results meet the criteria to be declared a useful or successful model. These are based on accuracy, balanced accuracy, precision, recall, and variations of the confusion matrix. Variations of the confusion matrix can include Mathew's Correlation Coefficient (MCC), True Positive/Negative rates, Precision Positive/Negative Predictive rates, Fowlkes-Mallow index, informedness, markedness (delta-p), etc. and models with the highest ratings, based on metrics set by the operator are deemed useful or successful models. Models with the highest ratings or top-n models can be configured to be selected as the “winner” models.

In the embodiment depicted in FIG. 6. The visualizer module 164 comprises three sub-modules: a dimensionality parser 612, a transformer 614, and a data graph constructor 616. The dimensionality parser 612 analyzes the dimensionality of the returned data results and selects an appropriate visualization approach that is suitable for the dimensionality of the data. Alternatively, the visualization approach can be prespecified by user parameters. For example, the dimensionality of the data can be used to determine whether the display of results will employ histograms, bar or pie charts, scatter or line plots, time series plots, relationship maps, heat maps, geo-tagged or geo-location based maps, 3-dimensional or higher dimensionality plots, animations or syntax or word based plots. The transformer module 614 transforms and structures the data set for visualization, and the data graph constructer 616 renders the visualization in a form required for the output module 168 to submit to the API 124. The API then transmits the data for the visualization to the display device for viewing via the user interface 125.

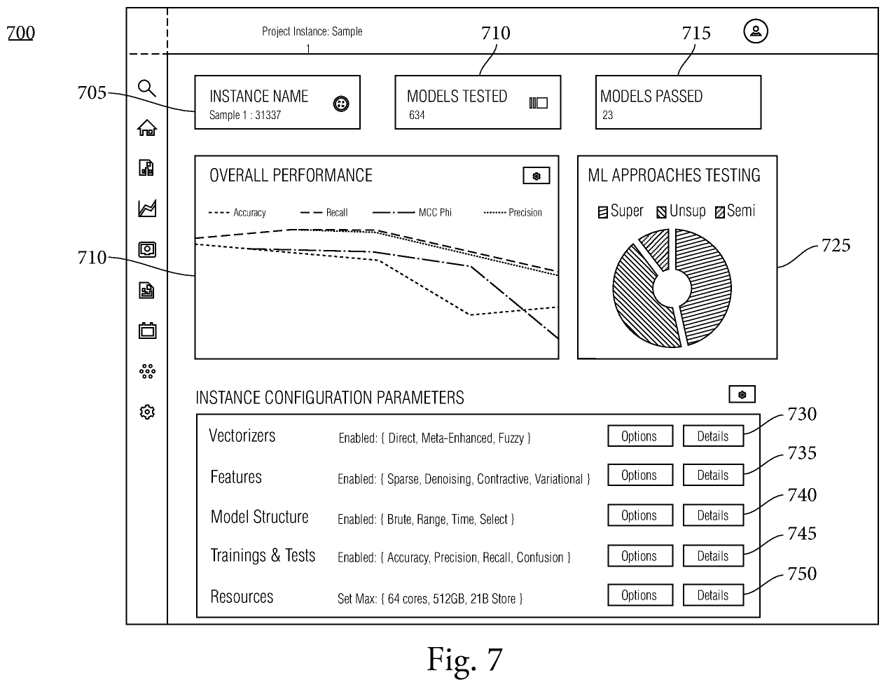

FIG. 7 shows a screen of an example user interface enabling the operator to configure aspects of the machine learning process. Toward the top of the interface screen 700, the interface includes a project element 605 that displays the name of the current project (e.g., “Sample 1”) and the size of the data set being investigated. Adjacent the project element 705 are a model tested indicator 710 and a model passed indicator 715. As their names imply the model tested indicator 710 displays the number of models tested using the project data, and the model passed indicator 715 displays the number of models tested that passed the accuracy criteria. The area of the screen directly below includes a performance display element 720 and a model approach element 725. The performance element 720 displays (in a graph or other form) performance statistics regarding the models tested in the project such as accuracy, precision and recall. The model approach element 725 is a pie chart that displays the fractions of models that fall into supervised, semi-supervised or unsupervised categories. This data can also be displayed in alternative forms.

The area below the performance and model approach elements includes a set of control elements that enable the operator to configure the modules discussed above and other settings. For example, a vectorizer control element 730 enables the operator to select, activate or disable one or more vectorization operations. A feature generator control element 735 enables the operator to select, activate or disable one or more autoencoder algorithms. A model structure element 740 enables the operator to select, activate or disable one or more of selecting structures and hyperparameters. A training and testing control element 745 enables the operator to set options for displaying performance, among other functions, and a resources control element 750 enables the operator to set an extent of computational resources to be allocated to the training and testing procedures of the project.

It is to be understood that the user interface screen 600 is only one of many different screen through which the user provides inputs for configuring, controlling and monitoring the numerous parameters and options available. For example, there will be a different user interface screen presented for each type of machine learning algorithm, as each algorithm requires different inputs, parameters and settings. The interface of FIG. 7 as well as the types of controls illustrated can be used with any of the embodiments described herein.

All output data, including visualized or general information output related to data sets, data vectorization, data set feature extractions, model selection, model structure, model hyperparameters, model and algorithm performance measures and metrics are handled by the output handler 168. In the embodiment depicted in FIG. 6, the output handler 168 also includes three submodules: a function parser 622, a transformer 624 and an API handler 626. The function parser 622 is configured to analyze output requests received from the model handler 146 or the visualizer module 164 and to determine a proper request type and structure label for data transformation appropriate for delivery to the API 124. The transformer sub-module 624 transforms all of the data sets to suitable output formats and then passes the transformed data sets to the API Handler 626. The API handler 626 submits a data output request to the API 124 for computation and constitution by the API. 124 The API 124 in turn provides the output data to the user-interface 125, enabling the operator or analyst to interface with the system and conduct analyses. Additionally, requests to the API 124 can be formed which cause the API 124 to send the same data to external systems for integration with other security systems, autonomic platforms, or other AI/ML based systems or solutions conducting analysis, research, or operational activities. This external delivery of the output data can be performed to solve a particularly complex problem, for example.

The system described above can be used for the application of machine learning in a systematic way to solve or shed light on a vast variety of problems. At the outset, it is not necessarily known which data set, data features, algorithmic approach, and model structure would be most effective. The training results provided by the visualizer 164 and output modules 168 according to this disclosure, however, identify important datasets and dataset features. This output informs the operators and can directly influence the selected algorithmic approach, the model structure and hyperparameters. By identifying the appropriate visualization approach that is suitable for the dimensionality of the data, the system better enables operators to evaluate multiple machine learning models to find the best collection of datasets, features, algorithms, and models for identification and classification. For example, certain types of machine learning models might be optimal for classifying certain types of data. In any event, differences in outcomes provide insight to the monitoring operators with respect to the pertinent problem.

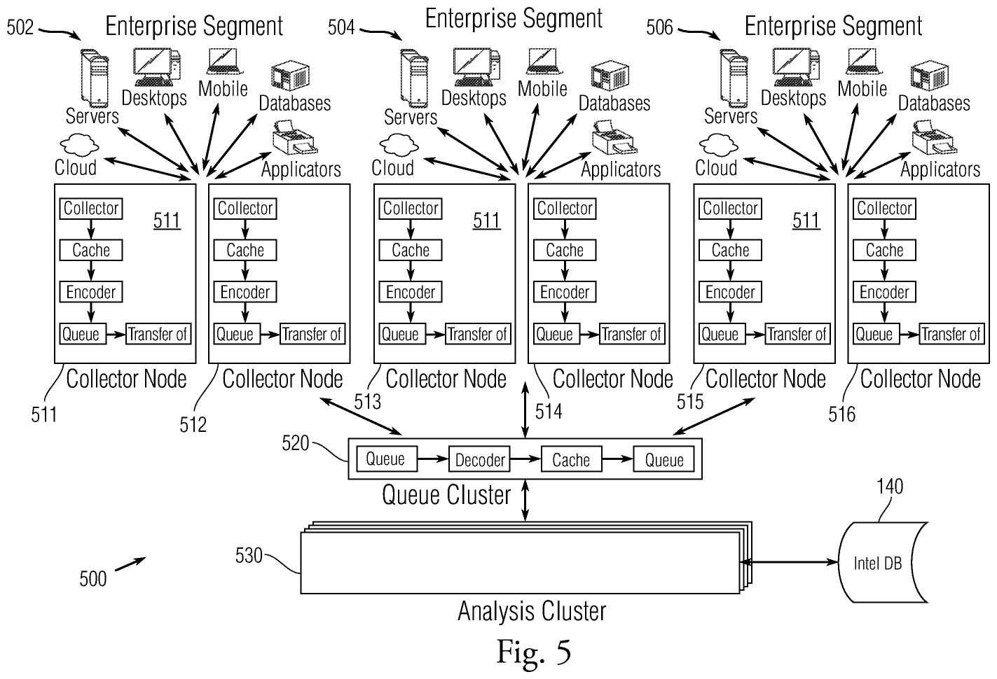

FIG. 5 depicts another embodiment of a system for data generation and visualization that employs a plurality of collector nodes and clusters of queue and analysis nodes to provide load balanced and simultaneous analysis for a large enterprise. The system 500 includes three enterprise segments 502, 504, 506, each comprising a plurality of computing resources. Segment 502 supplies artifacts to collector nodes 511 and 512. Segment 504 supplies artifacts to collector nodes 513 and 514, while segment 506 supplies artifacts to collector nodes 515 and 516. The collector nodes 511-516 can be similar to those described above. Collector nodes 511-516 send the collected files to a central queue cluster 520. The queue cluster can include a plurality of queue, decoder and cache modules that can each operate similarly to the modules 114-117 described above with respect to FIG. 1, operating at the direction of code executing in a processor. The cluster of modules of the queue cluster 520 operate in parallel to process large request loads. The queue cluster is configured by code to queue requests for an analysis cluster 530 which include a plurality of analysis modules similar to the analysis module 130 described above. The plurality of analysis modules in the analysis cluster 530 also operate in parallel to provide load balanced, simultaneous analysis of file artifacts to handle higher volumes of files and artifacts. The analysis cluster 530 delivers analysis output to the central intelligence database 150.

The disclosed systems and methods provide an end-to-end approach to solving problems utilizing machine learning in a broad and flexible manner. The systems and methods include intelligence database integration and correlation, fuzzing of feature selections, and various output visualizations and API functionality for integration with other cybersecurity operational systems.

Organizations can utilize the disclosed system and methods to collect datasets, transform data, and identify essential and important features that models use to solve a specific problem using machine learning. The solution helps identify the optimal datasets, features, algorithms, model structure, and model hyperparameters which perform best in solving specific use-case problems. Additionally, the disclosed systems and methods, when implemented, can be utilized for full machine learning lifecycle development, testing, training, and operationalization, including model retraining, model retention, model bias, and model decay over time.

There are many types of applications to which the machine learning system of the present disclosed can be gainfully applied. For example, uses in the cybersecurity field in include domain look-alike (doppelganger) identification, anomaly detection across user behaviors, anomaly detection on logs, anomaly detection on network behaviors, anomaly detection on a sinkhole (where it is collecting data—like a blackhole on the network), and authentication-based anomaly detection.

Another useful function that this system and method provides is in optimizing other machine learning processes. For example, the disclosed system can be used to assess and retrain existing models, or to replace existing models entirely with new models that have proven to be better predictors for a specific problem or use case. Normally, as models are trained utilizing a specific set of data relevant to the context of an organization's environment, they are useful and effective. But over time, as the datasets, users, user behavior patterns, adversarial patterns, tools and tactics change. This can render models that were previously successful predictors ineffective. Having a system that can continuously ingest existing data sets, vectorize, featurize, and test numerous possible models across various approaches allows it to quickly identify better vectorization approaches, feature generation approaches, better ML approaches, with models with better hyperparameters and structures allowing for the model to be retrained or replace entirely to meet a project objective. In this case, the model handler can pull and push models from the Machine Learning operational systems (AI/ML platform), and retrain, replace, or augment an existing model to cover other gaps, in order to make the entirety of the approach meet the project prediction objectives.

It should be understood that all of the system components described herein such as collector nodes, analysis modules, etc. are embodied using computer hardware (microprocessors, parallel processors, solid-state memory or other memory, etc.), firmware and software as understood by those of skill in the art and can include servers, workstations, mobile computing devices, as well as associated networking and storage devices. Communications between devices can occur over wired or wireless communication media and according to any suitable communications system or protocol.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the invention has been described with reference to exemplary embodiments, it will be understood by those skilled in the art that various changes can be made and equivalents can be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A non-transitory computer-readable medium comprising instructions which, when executed by a computer system, cause the computer system to carry out a method of machine learning data generation and visualization, the method including steps of:
receiving a data file containing data pertinent to a problem to be addressed using a machine learning model;
extracting features from the data file;
vectorizing the extracted features using a plurality of vectorization techniques into vectorized feature data;
generating data features with reduced dimensionality from the vectorized feature data using a plurality of autoencoding techniques;
selecting an artificial intelligence/machine learning (AI/ML) model to analyze the data features with reduced dimensionality;
receiving results of an execution of the selected AI/ML model;
parsing a dimensionality of the received results;
selecting a visualization approach for the received results based on the dimensionality;
outputting the selected visualization of results of the execution of the selected AI/ML model.

2. The non-transitory computer readable medium of claim 1, further comprising instructions which, when executed by a computer system, cause the computer system to execute the steps, prior to vectorization, of:
recursively extracting data embedded in the data file; and
extracting meta-data from the data file and artifacts obtained from recursive extraction.

3. The non-transitory computer readable medium of claim 1, further comprising instructions which, when executed by a computer system, cause the computer system to execute the steps, prior to vectorization, of performing a query on a database based on the data in the file and extracted meta-data.

4. The non-transitory computer-readable medium of claim 1, wherein the method further comprises, after selecting a visualization approach and before outputting the selected visualization of results, transforming and structuring the results of the execution of the selected AI/ML model for the selected visualization approach.

5. The non-transitory computer-readable medium of claim 4, wherein the visualization approach includes one or more of a histogram, a bar chart, a pie chart, a plot, a line plot, a time series plot, a relationship map, a heat map, a geo-tagged or geo-location-based map, a three-dimensional map, an animation, a syntax-based plot, and a word-based plot.

6. The non-transitory computer-readable medium of claim 1, wherein the plurality of vectorization techniques includes direct vectorization, meta-enhanced vectorization and fuzzy vectorization.

7. The non-transitory computer-readable medium of claim 1, wherein the plurality of autoencoding techniques include sparse, denoising, contractive, and variational autoencoding.

8. The non-transitory computer-readable medium of claim 1, wherein the selected AI/ML model comprises a supervised machine learning model.

9. The non-transitory computer-readable medium of claim 8, wherein the model handler includes a hyperparameter selector module for enabling selection of parameters for execution of the selected supervised machine learning model including at least one of a learning rate, a number of epochs and a batch size.

10. A system for machine learning data generation and visualization comprising:
one or more processors, the processors having access to program instructions that when executed, generate the following modules:
a queue module configured to receive a data file pertaining to a problem to be addressed using a machine learning model;
a feature selector module configured to select features extracted from the data file;
a vectorizing module configured to generate vectorized feature data from the features selected by the feature selector module using a plurality of vectorization techniques;
a feature generation module configured to generate data features with reduced dimensionality from the vectorized feature data using a plurality of autoencoding techniques;
a model handler module configured to select an artificial intelligence/machine learning (AI/ML) model to analyze the data features with reduced dimensionality, to transmit the model for execution, and to receive the results of the execution of the selected AI/ML model;
a visualizer module configured to parse a dimensionality of the results obtained by the model handler module and to select a visualization approach for the obtained results based on the dimensionality; and
an output module configured to provide the results to a device for rendering the visualization approach selected by the visualizer module.

11. The system of claim 10, further comprising:
a recursive extractor module configured to recursively extract data embedded in the data file; and
a meta-data extractor module configured to extract metadata from the file and artifacts obtained from the recursive extractor module.

12. The system of claim 11 further comprising a query module configured to performing a query on a database based on the data in the file and extracted meta-data.

13. The system of claim 10, wherein the visualizer module is further configured to transform and structure the results of the execution of the selected AI/ML model for the selected visualization approach after selecting a visualization approach and before outputting the selected visualization of results.

14. The system of claim 13, wherein the visualization approach selected by the visualizer module includes one or more of a histogram, a bar chart, a pie chart, a plot, a line plot, a time series plot, a relationship map, a heat map, a geo-tagged or geo-location-based map, a three-dimensional map, an animation, a syntax-based plot, and a word-based plot.

15. The system of claim 10, wherein the vectorizer module is configured to vectorize feature data using direct vectorization, meta-enhanced vectorization and fuzzy vectorization.

16. The system of claim 10, wherein the feature generation module is configured to generate URL data features using sparse, denoising, contractive, and variational autoencoding.

17. The system of claim 10, wherein the selected AI/ML model selected by the model handler module comprises a supervised machine learning model.

18. The system of claim 13, wherein the model handler module includes a hyperparameter selector that is to receive parameters for execution of the selected supervised machine learning model including at least one of a learning rate, a number of epochs and a batch size.
